(19) United States
(12) Patent Application Publication
(10) Pub. No.: US 2024/0289553 A1
(43) Pub. Date: Aug. 29, 2024

(54) CONVERSATIONAL INCLUSION/EXCLUSION DETECTION

(71) Applicant: Insight Direct USA, Inc., Chandler, AZ (US)

(72) Inventor: Scott Joynt, Delaware, OH (US)

(21) Appl. No.: 18/113,187

(22) Filed: Feb. 23, 2023

(51) Int. Cl. G06F 40/30; G06F 40/284; H04L 51/212

(52) U.S. Cl. CPC G06F 40/30; G06F 40/284; H04L 51/212

(57) ABSTRACT

A method of evaluating a proposed message to a conversation for inclusion or exclusion comprising recording messages of the conversation, extracting a relevant subset of the recorded messages, evaluating a thread length of the relevant subset of the recorded messages, and generating a conversation model from the relevant subset in response when thread length is sufficient. Relevance of the proposed message is scored according to the conversation model and compared threshold criteria. If this comparison indicates sufficient correlation between the conversation and the proposed message, the proposed message is submitted to the conversation; otherwise, a user prompt is generated querying whether the proposed message should be submitted to the conversation, and user approval is required before the proposed message is entered into the conversation.

### BACKGROUND

The present disclosure relates generally to natural language processing, and more particularly to a system and interface for evaluating conversational strings for inclusion in, or exclusion from, a conversation thread.

Messaging applications are commonly used to facilitate asynchronous communication between multiple users in the form of ongoing conversations. In such applications, locally generated messages are added to a conversation and transmitted to other conversation participants once submitted by their originator. Existing add-ons for messaging applications include tools to evaluate prospective new messages and provide feedback to users before such messages transmitted. For example, spelling and grammar check modules are commonly used to highlight potential errors in a message so that the user can make corrections before transmitting the message. In another example, some messaging applications include profanity filters that prevent transmission of messages including certain words or phrases, or that provide a prompt to the user requiring confirmation before a message including potentially offensive language will be sent.

Over time, a single user may participate in several concurrently ongoing message threads. This diversity of different threads introduces possibilities for error. A user may inadvertently submit messages to the wrong conversation or recipients, or may send a message to an intended recipient including unintended content (e.g. by copying and pasting unintended information). Such errors are often minor embarrassments or inconveniences, but can in extreme cases even constate illegal or unprofessional disclosures of confidential, proprietary, or protected information. Users are generally responsible for monitoring their own messages to prevent negligent or embarrassing communication, and a degree of human error is therefore inevitable.

### SUMMARY

This disclosure presents a method of evaluating a proposed message for inclusion or exclusion in a conversation. This method includes recording messages of the conversation, extracting a relevant subset of the recorded messages, evaluating a thread length of the relevant subset of the recorded messages, and generating a conversation model from the relevant subset in response when thread length is sufficient. Relevance of the proposed message is scored according to the conversation model and compared threshold criteria. If this comparison indicates sufficient correlation between the conversation and the proposed message, the proposed message is submitted to the conversation; otherwise, a user prompt is generated querying whether the proposed message should be submitted to the conversation, and user approval is required before the proposed message is entered into the conversation.

This disclosure also presents a conversational input evaluation system that includes a conversation record, a local user input module, and a conversational inclusion filter. The conversational record archives a conversation including a plurality of past messages. The local user input module is accessible to a local user, and is configured to submit a proposed message from the local user for inclusion in the conversation. The conversational inclusion filter is disposed to receive and evaluate the proposed messages, and includes a dynamic conversation model produced by a machine learning (ML) module. The dynamic conversation model is operable on the proposed message to generate a relevance score denoting relevance of the proposed message to the conversation. The ML module is configured to generate and update the dynamic conversation model based on a current state of the conversation record. The conversational inclusion filter is configured to transmit a query to the local user in the event that the relevance score fails to satisfy threshold criteria for relevance to the conversation, and to permit the proposed message to be transmitted only if the relevance score generated for the proposed message indicates that the proposed message satisfies threshold criteria for relevance to the conversation, or if the local user confirms transmission of the proposed message in response to the query.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a system flowchart illustrating a system for conversational inclusion/exclusion evaluation.

FIG. 2 is an illustrative user interface screenshot for use within the system of FIG. 1.

FIG. 3 is a method flowchart illustrating conversational inclusion evaluation compatible with the system of FIG. 1.

FIG. 4 is a method flowchart illustrating an alternative method of conversational inclusion evaluation including dynamic input weighting.

FIG. 5 is a system flowchart illustrating a generalization of the system of FIG. 1 to handle multiple parallel conversations.

FIG. 6 is a method flowchart illustrating an alternative approach to the methods of FIG. 3 or 4, adapted to the process of FIG. 5.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure provide methods and associated systems to flag prospective new messages for user confirmation before inclusion in a conversation based on relevance to previous strings in that conversation. Evaluation of each new input is conditioned upon availability of a sufficient sample of recent strings in the same conversation. Machine learning is used to dynamically generate a model specific to the current state of conversation, based on these strings. The new prospective message is evaluated based on this model to assign a relevance score. If the relevance score of the new input fails to satisfy relevance criteria, the user is prompted to confirm the message before the message is sent. Several versions of these methods and system are provided in detail below. Except where otherwise specified, these methods and systems are not mutually exclusive and can be combined freely and/or supplemented with additional implementations or variations such as would be available or apparent based on the present figures and description, without departure from the scope and spirit of this disclosure.

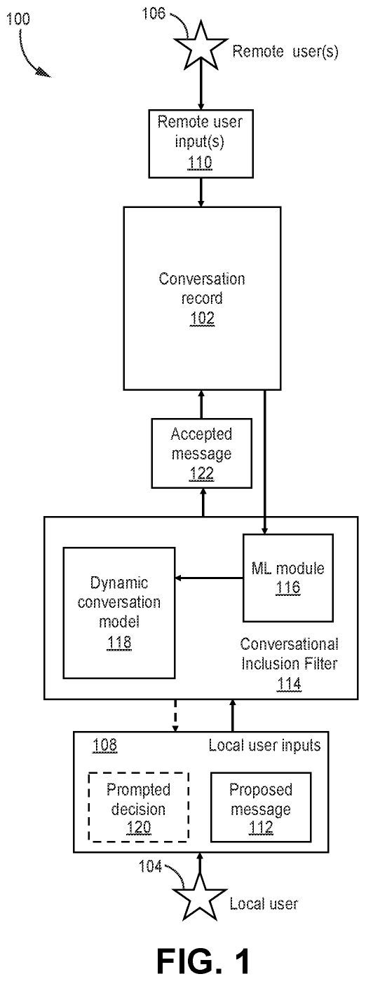

FIG. 1 illustrates system 100, a system for conversational input evaluation. System 100 includes conversation record 102, which receives contributions from local user 104 and remote user(s) 106 via local user inputs 108 and remote user inputs 110, respectively. Although system 100 is presented generally from the perspective of local user 104, local user 104 need not have a privileged role in system 100. In general, although the present disclosure focuses on local user 104 rather than remote user(s) 106, system 100 can be generalized or recontextualized to evaluate prospective conversational inputs from any user, without change in function.

Conversation record 102 records a conversation composed of at least one message, with each message originating with a user (104 or 106) included on the thread. For the purposes of this disclosure, the terms “conversation” and “thread” are used interchangeably. Conversations can also include recipient users that have not contributed messages to the conversation, or that in some instances cannot contribute to the conversation. Each message can include a text string and/or other media, e.g. images, video, or embedded hyperlinks. Conversation record 102 can, for example, be a locally stored record in persistent storage media of all messages received by local user 104 through system 100, or at least of all messages received within a set timeframe. Conversation record 102 can also include a timestamp associated with each message to identify when the message was submitted to the conversation. In some instances, conversation record 102 can instead be stored in a cloud-based or otherwise remote physical location. In these various examples, the message timestamps stored in conversation record 102 can include transmission timestamps provided by each message's sender, and/or receipt timestamps attached to each message when received and added to conversation record 102.

Local user inputs 108 include proposed message 112, which are processed by conversational inclusion filter 114, as described in detail below. Proposed message 112 is a message generated by local user 104 for submission to the conversation captured in conversation record 102, but not yet transmitted to other users or recorded in conversation record 102. Although inputs from any user can potentially by filtered for conversation inclusion before being submitted to the conversation (and to other users) and reflected in conversation record 102, the present disclosure focuses on conversation inclusion filtering of proposed messages 112. Although not explicitly depicted or discussed herein, any remote user(s) 106 can also be provided with a corresponding conversational inclusion filter 114 operating generally as described below with respect to local user 104.

Conversational inclusion filter 114 incudes machine learning (ML) module 116, a software module including an ML modeling algorithm configured to generate dynamic conversation model 118 from contents of conversation record 102, and update dynamic conversation model 118 based on aging of and additions to conversation record 102. ML module 116 can, for example, incorporate Natural Lange Toolkit (NLTK) libraries in Python. In the most general case, dynamic conversation model 118 can be any model capable of scoring a degree of relevance (i.e. a model prediction percentage) of proposed message 112 to conversation recorded in conversation record 102 or a portion thereof. Similarly, ML module 116 can be any software module capable of analyzing natural language extracted from all or part of conversation record 102 to produce such a model.

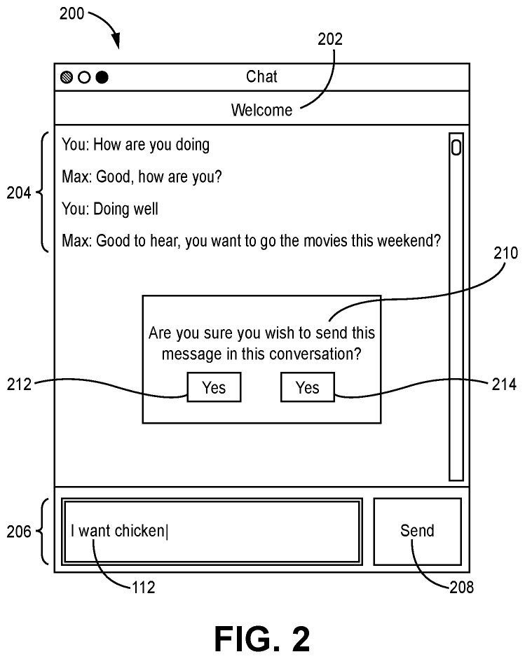

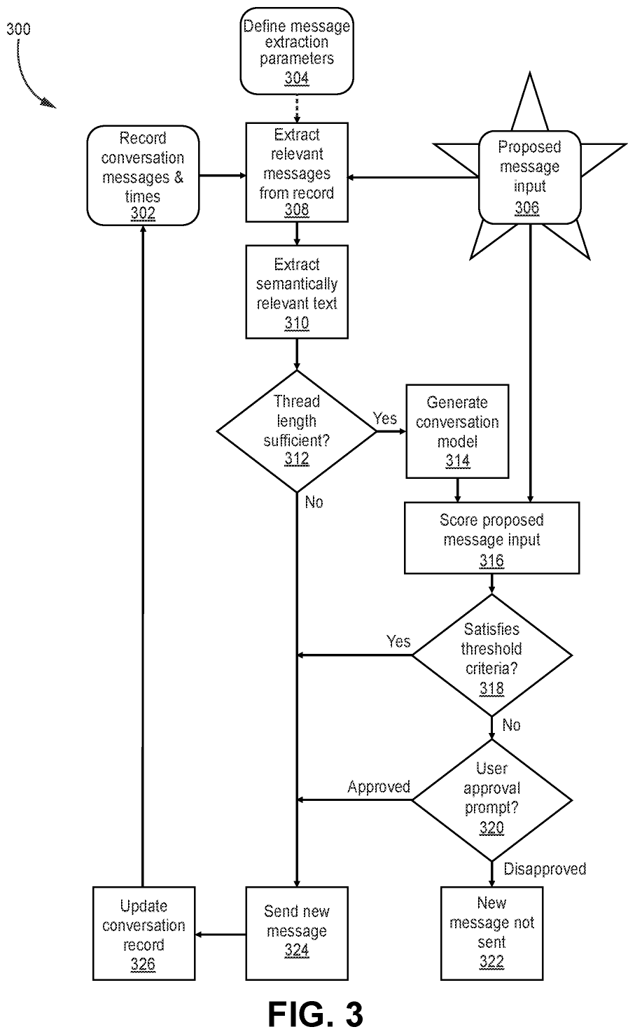

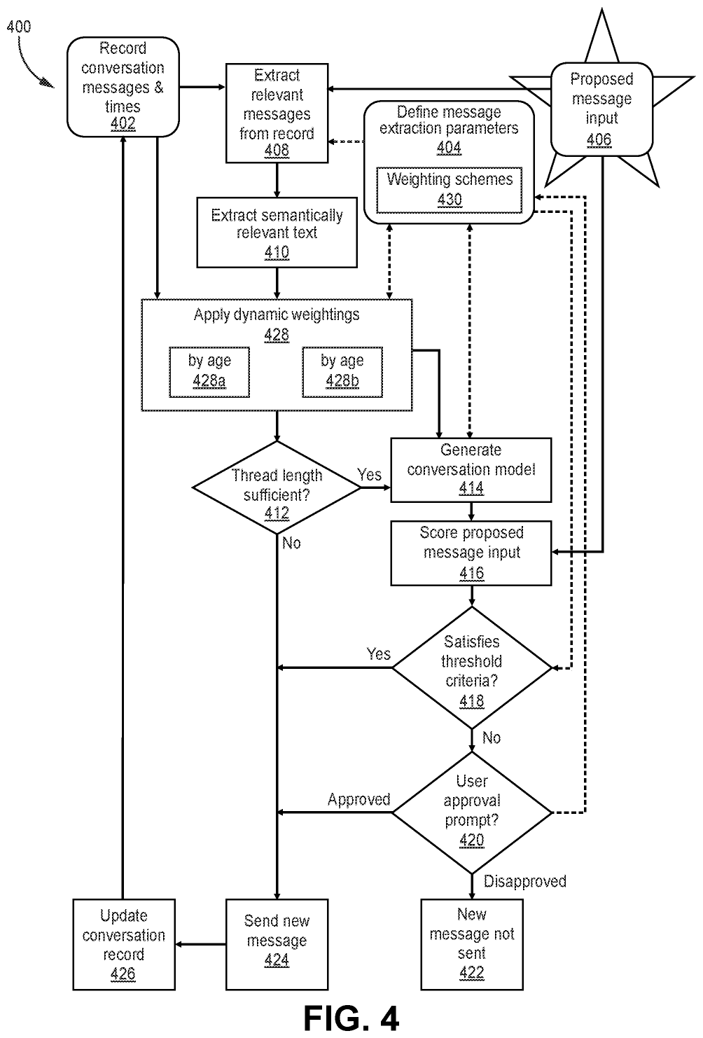

Through processes described in detail with respect to FIGS. 3 and 4 (see below), conversational inclusion filter 114 tests each proposed message 112 for relevance to conversation record 112 using dynamic conversation model 118. If a scoring of proposed message 112 generated from dynamic conversation model 118 satisfies threshold criteria for relevance, proposed message 112 is transmitted as accepted message 122 (visible to remote user(s) 106), and enters conversation record 102. If the scoring of proposed message 112 generated by dynamic conversation model 118 fails to satisfy threshold criteria for relevance, proposed message 112 is flagged as possibly sent in error. Local user 104 is prompted to decide whether the message should be sent (see FIG. 2), and this prompted decision is returned to conversational inclusion filter 114. If confirmed, proposed message 112 is transmitted as accepted message 122. If rejected, proposed message 112 is either discarded or retained, unsent, as discussed in greater detail below.

Conversational inclusion filter 114 can be implemented as an add-on to a local messaging app used by local user 104, i.e. as software interfacing with existing software local to or otherwise accessed by local user 104. Alternatively, conversational inclusion 114 can be an inseparable functional component of such a messaging app. In the most general case, conversation record 102 and ML module 116 are either stored in durable readable memory, or are generated transiently, as needed, from durable storage located elsewhere. Conversational inclusion filter 114 can be implemented by any processor or similar logic-capable device accessible (locally or remotely) to local user 104.

FIG. 2 depicts user interface (UI) 200 in an illustrative snapshot showing a user prompt as described above. User interface 200 provides one non-exclusive example of an interface for use with system 100, and includes header 202, conversation record entries 204, message entry box 206, send button 208, and prompted message 210 with buttons 212, 214 to respectively confirm or reject the message entered in message entry box 206.

As noted above with reference to FIG. 1, each proposed message 112 generated by local user 104 is tested by conversational inclusion filter 114 before transmission. Conversation record entries 204 represent at least a portion of (e.g. the most recent) messages in the current thread, as retained in conversation record 102. Successive messages from contributing users are shown, e.g. in chronological order, in UI 200. The illustrated example depicts conversation record entries 204 including a polite exchange terminating in a question (“you want to go to the movies this weekend?”).

Local user 104 generates proposed message 112 in message entry box 206. In the illustrated example, proposed message 112 is a contextually out-of-place statement (“I want chicken”) not relevant to conversation record entries 204. Conversation inclusion filter 114 therefore flags proposed message 112 as possibly irrelevant (and therefore submitted in error), and triggers generation of prompted message 210. In the illustrated embodiment, proposed message 112 is not transmitted until and unless local user 104 affirmatively approves it (i.e. by clicking “yes” button 212), and is either discarded or retained in message entry box 206 unsent if local user 104 rejects proposed message 112.

As depicted in UI 200, prompted message 210 can, for example, be a popup window or pane requiring local user 204 to explicitly confirm that the message should be sent before proposed message 112 is transmitted as accepted message 122. In this example, conversational inclusion filter 114 may evaluate proposed message 112 only when local user 104 submits proposed message 112 (e.g. by clicking send button 208, or through a carriage return or other hotkey). In other examples, however, prompted message 210 can take other forms such as an in-line message adjacent conversation record entries or message entry box 206 or a change (e.g. in text, color, or other presentation) in message entry box 206. Furthermore, although the present disclosure principally assumes that proposed message 114 is submitted for evaluation by conversational inclusion filter 114 when local user 104 attempts to transmit the message, some embodiments may also submit proposed message 114 for evaluation by conversational inclusion filter 114 at other times, e.g. periodically or after a sufficient idle period by user 104 after text has been entered in message entry box 206.

In addition to illustrating one example of a functional UI to solicit user confirmation before transmitting possibly erroneous messages flagged by conversational inclusion system 100, FIG. 2 provides an example of a proposed message 112 with low relevance to preceding messages in conversation record 102—suggesting chicken (a meal preference?) in response to a question about weekend plans and movies. Methods employed by conversational inclusion filter 114 to evaluate relevance are described in detail below with respect to FIGS. 3-6.

FIG. 3 is a flowchart illustrating method 300 for implementation by system 100. Method 300 sets out a process for evaluating proposed message 112 by using ML module 116 to generate dynamic conversation model 118, as described above with reference to FIG. 1.

Conversation record 102 records messages (i.e. message contents) in a thread together with corresponding timestamps, as noted above. (Step 302). This is accomplished by recording all transmitted messages, whether originating from local user 104 or remote user(s) 106, in a table, database, or other storage element instantiated in durable or transient machine-readable memory. At a minimum, conversation record 102 provides an archive of semantic information from transmitted user messages, together with at least one timestamp per message entry. Conversation record 102 can additionally include the full contents of messages. In some embodiments, conversation record 102 can periodically be cleaned, e.g. to purge messages older than a threshold time age.

System 100 also defines message extraction parameters. (Step 304). Message extraction parameters, as described herein, refer to rules by which conversational inclusion filter 114 identifies messages or parts of messages from within conversation record 102 as potentially relevant to at least some degree as input for ML module 116 for the generation or updating of dynamic conversation model 118. When a new message input is submitted (Step 306) by local user 104, e.g. using UI 200, a timestamp is associated with the new message input and relevant messages are extracted from conversation record 102 (Step 308) based on the message extraction parameters and the new message timestamp. In the principal embodiment contemplated herein, only text is extracted at step 308 from conversation record 102. Message extraction parameters can specify an earliest permissible timestamp of messages from conversation record 102 for inclusion, depending on the new message timestamp. For example, the message extraction parameters may specify that only messages having corresponding timestamps within five minutes of the new message timestamp should be extracted as relevant messages. This time-based filter excludes earlier and likely less relevant messages from consideration when building dynamic conversation model 118, and can be generalized further as described with reference to FIG. 4. Message extraction parameters provided at step 304 can also, for example, exclude messages or portions of messages without text content, such as videos, images, emojis, or hyperlinks.

Once relevant messages have been extracted from conversation record 102 at step 308 in the form of text strings, conversational inclusion filter 114 extracts semantically relevant text from the relevant messages. (Step 310). Specifically, each message is tokenized, i.e. broken down into parts of speech (noun, verb, adverb, etc.) based on words and structure. Conjunctions and articles can then, in some embodiments, be discarded. Each remaining word is then stemmed, i.e. truncated to its root word-“running” to “run.” for example. These tokenized, stemmed words from of the extracted relevant messages is then filtered to remove stop words or phrases, i.e. phrases that are merely responsive rather than additive to the semantic content of the selected portion of conversation. Stemming, tokenizing, and stop word removal can be performed using known approaches, e.g. with publicly available libraries such as the StanfordNLP Python library made available by the Stanford Natural Language Processing group. In some exemplary embodiments, the extraction of relevant text can include simplification and potentially tokenization of idiomatic language or non-textual semantic content such as emojis and/or stamps, e.g. by reference to an incorporated library or libraries implemented by conversational inclusion filter 114.

Once each relevant message extracted at step 308 has been simplified into semantically relevant text at step 308, conversational inclusion filter 114 evaluates whether a thread length of remaining messages in the conversation is sufficient to generate a useful conversation model 118. (Step 312). As contemplated in FIG. 3, this step constitutes ascertaining whether a count of remaining messages exceeds a preset minimum number. FIG. 4 presents a generalized alternative, as discussed below. Longer required thread length generally increases the predictive capacity of dynamic conversation model 118, albeit with diminishing returns—generally, older messages are less likely to be directly relevant to new prospective messages. In some embodiments, for example, step 312 can require a minimum substantive message count (i.e. after stop word/sentence removal) of four. In other embodiments, as described in greater detail with reference to FIG. 4, message count can be evaluated more granularly.

If the thread extracted relevant thread length is too short to permit generation of a useful conversation model 118, conversational inclusion filter 114 passes proposed message 112 through for transmission as accepted message 122 without any action visible to local user 104. (Step 324). If the thread length is sufficient to permit useful conversational modeling (i.e. above the preset threshold message count), the semantically relevant text is provided to ML module 116, which generates dynamic conversation model 118 therefrom. (Step 314). Although ML module 116 generates dynamic conversation model 118 from the semantically relevant text extracted at step 210, some embodiments of ML module 116 can additionally or alternatively use other data in the construction of dynamic conversation model 118.

As described above with reference to FIG. 1, dynamic conversation model 118 is a model reflecting the semantic content of the extracted relevant messages, and evaluable against proposed message 112 to generate a quantitative measure of relevance. This measure of relevance—termed a “model predictive percentage” or “class score,” or more generally a “relevance score”—reflects the degree to which proposed message 112 matches or would otherwise be expected in the semantic context provided by the extracted relevant messages. As noted above, ML module 116 can use an existing library such as NLTK in Python can be used to generate dynamic conversation model 118.

Once a dynamic conversation model 118 specific to the current state of conversation record 102 has been generated, that model is used to score proposed message 112. (Step 316). Referring to the example provided in FIG. 2, a proposed message 112 of “I want chicken” has low relevance to the preceding conversation, which included greeting queries (“How are you doing—Good, how are you?”) and a specific question about weekend movie plans (“you want to go to the movies this weekend?”). Alternative proposed messages 112 could have higher relevance (“I'd like to, but I'm too busy this weekend”-responding to the query regarding weekend plans), extremely high relevance (“I'd be interested in a movie Saturday, if that works.”—explicitly referring to “Saturday” and “movie”), or even lower relevance (“the average chicken weighs less than six pounds”—still not responsive to “movie” or “weekend,” but also not relevant to “want” from the preceding message). Dynamic conversation model 118 assigns a numerical score (herein referred to as a “relevance score”) to new proposed message 112 reflecting this relevance. For the purposes of further description, a higher score is presumed to denote greater relevance, and a lower score less relevance, but this need not be the case; generally, any quantitative score reflecting relevance to the extracted messages will suffice.

Once proposed message 112 has assigned a relevance score based on dynamic conversational model 118, conversational inclusion filter 112 compares the relevance score against threshold criteria to ascertain proposed message 112 appears sufficiently relevant to preceding messages. (Step 318). Carrying forward the preceding example wherein a higher score denotes greater relevance, the threshold criteria can include a threshold relevance score, such that a proposed message 112 with a relevance score greater than a preset value is deemed relevant and therefore permissible, while a proposed message 112 with a lower score lower than this value is deemed questionable. If the relevance score satisfies threshold criteria, the proposed message is transmitted as accepted message 122. (Step 324). If not, a prompt is provided to local user 104 requiring approval before the message will be transmitted, as described above with reference to FIGS. 1 and 2. (Step 320). If local user 104 rejects the message, it is not sent (Step 322), and is instead either retained in unsent form to be revised, i.e. in message entry box 206 (see FIG. 2), or discarded altogether. If local user 104 approves the message, it is transmitted as accepted message 122 (Step 324), notwithstanding the indication of low likely relevance as assessed by conversational inclusion filter 114. Conversation record 102 is then updated to reflect the addition of accepted message 122, (Step 326) and the conversation continues.

FIG. 3 illustrates one iteration of method 300. As conversation continues, method 300 can repeat with each new proposed message 112 from local user 104. Similarly, although this disclosure focuses on messages from local user 104, separate instances of method 300 can be performed for each remote user(s) 106 in system 100. Although method 300 is described as generating a new dynamic conversation model 118 at step 314 of each iteration, some alternative embodiments of ML module 116 can make use of additional information, e.g. using previous iterations of dynamic model 118 as inputs (where available) when generating new versions of dynamic conversation model 118. Furthermore, although system 100 is described herein primarily as producing a single dynamic model from conversation record 102 in each iteration of method 300, alternative versions of method can use multiple ML algorithms 116 to generate multiple dynamic conversation models 118 that are separately used to score each proposed message 112 (Step 316). In such cases, threshold criteria can differ for each model, and satisfaction of threshold criteria (at step 318) can in alternative embodiments require adequate relevance score in any, all, or at least a specified number of models. In some embodiments, multiple ML algorithms may be used to generate multiple models, with weightings assigned to separate models based, e.g. on historical predictive efficacy based on user approval responses (at step 320) on a per-conversation or per-user basis.

FIG. 4 is a flowchart illustrating method 400, which is an extension or generalization of method 300. Where not otherwise specified herein, all steps of method 400 function generally as described above with respect to corresponding elements of numbers one hundred lower in method 300. Compared to method 300, method 400 provides for weighted inclusion of message information for generation of dynamic conversation model 118.

As described above with respect to FIG. 3, conversational inclusion filter 114 extracts potentially relevant messages (Step 408) recorded (Step 402) in conversation record 102 using defined (Step 404) message extraction parameters. Semantically relevant text is then extracted from these relevant messages, as described above. (Step 410). In some embodiments, message extraction parameters can also specify alternative or additional rules affecting the inclusion of messages within the extracted, potentially relevant set. For example, older messages can be deemed potentially relevant and extracted (Step 408) from conversation record 102 if relevant, e.g. according to an evaluation by an earlier dynamic conversational model 118, to more recent messages. Alternatively or additionally, timestamp-based rules for extraction of potentially relevant messages from conversation record 102 can be dynamic selected based at least in part on conversation record 102 (Step 404), e.g. adjusting message extraction parameters based on cadence of conversation in conversation record 102. For example, if conversation record 102 indicates that messages between users are less frequent, i.e. that the cadence of conversation reflected in conversation record 102 is slow, then a aging limit of messages to be extracted as potentially relevant at step 408 can be relaxed. In another example, an absolute aging limit of messages to be extracted can be relaxed so long as all included messages comprise volleying exchanges without long pauses. These limits can be applied instead of, or in addition to, absolute aging limits. For example, twenty messages evenly distributed over ten minutes might be permitted, while two messages separated by a five minute pause might not.

Unlike method 300, however, method 400 evaluates the conversation record 102, the message extraction parameters, and/or the semantically relevant text to generate dynamic weightings (Step 428) used for model generation and/or thread length evaluation. These dynamic weights can include age-based (Step 428a) and count-based (428b) weightings, among others. Dynamic weights offer flexibility over using strict threshold tests alone. For example, instead of or in addition to excluding some messages based on age relative to the new message timestamp, method 400 allows the message extraction parameters to define weighting schemes 430 within the message extraction parameters, permitting a broader set of potentially relevant messages to be extracted from conversation record 102 (step 408) by, e.g., allowing marginally relevant or irrelevant messages according to method 300 to be assigned fractional weights in model generation (step 414) and/or thread length evaluation (412). For example, shorter messages with less semantic content and/or older messages deemed less likely relevant (but not irrelevant) to the latest message may be assigned fractional thread length for evaluation at step 412. Similarly, particular tokenized words can, for example, be assigned greater weighting at model generation (step 414) based on age, so as to give particularly high weight to the most recent messages, or based on syntax, e.g. to give particularly high weight to messages communicating questions and therefore prompting response.

Method 400 illustrates message extraction parameters receiving input based on user decisions made at step 420. Specifically, in some embodiments message extraction parameters can be relaxed or tightened based on rates of approval or disapproval of proposed messages 114 by local user 104, when prompted. For example, conversational inclusion filter 114 can drive towards a target user disapproval rate, e.g. 60% (indicating that proposed message 114 was correctly identified as irrelevant to the ongoing conversation), by varying scoring criteria (e.g. thresholds) evaluated at step 418 to be more permissive if local user 104 usually approves messages flagged as likely irrelevant, or less permissive if the local user almost never approves a flagged message (in which case the threshold criteria may be catching only extremely irrelevant messages).

The variations provided by method 400 over method 300 are not intended to be an exhaustive list of ways in which message extraction parameters can be used or adjusted over iterations of method 400. Other permutations of the disclosed methods permitting model generation or score evaluation factors to be adjusted based on system performance and historical specifics of conversation record 102 can also be incorporated into operation of method 100 without departure from the intended scope of the present disclosure.

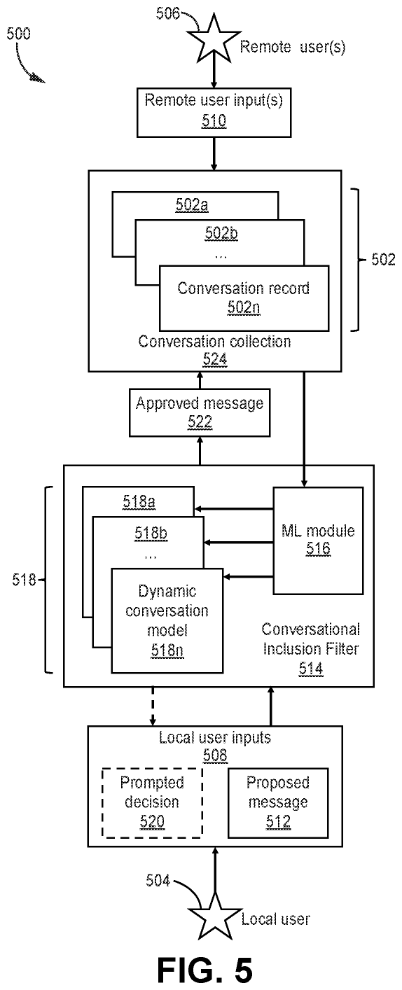

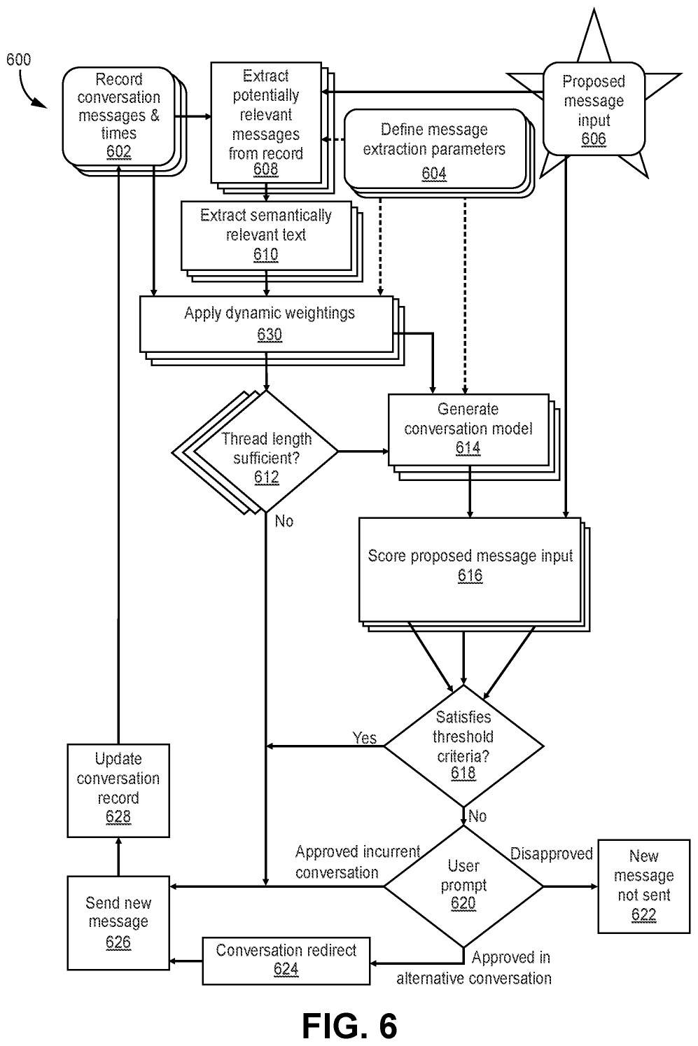

FIG. 5 is a flowchart illustrating system 500, a generalization of system 100 to address multiple ongoing conversations in which local user 504 may participate concurrently. Similarly, FIG. 6 is a flowchart of method 600, which is a simplified adaptation of method 400 to system 500. FIGS. 5 and 6 are discussed together. Where not otherwise specified, all components of system 500 behave generally as described above with respect to corresponding elements of numbers four hundred lower in method 100, and all steps of method 600 similarly function as described above with respect to corresponding elements two hundred lower in method 400.

To accommodate a multiplicity of separate parallel conversations in which local user 504 may be engaged, system 500 includes conversation collection 524 containing multiple distinct conversation records 502a, 502b, . . . 502n (generically 502), each representing one conversation with its messages and corresponding timestamps. Each message transmitted from local user 504 and/or remote user(s) 506 is directed to a single conversation represented by a single conversation record 502. Each new proposed message 512 generated by local user 504 is submitted in a specific one of conversation records 502. System 500 and method 600 differ from system 100 and method 400, respectively, in providing additional means for detecting when proposed message 512 is misdirected—i.e., when proposed message 512, although submitted in one conversation record 502, is a better match for a different conversation. To perform this evaluation, conversational inclusion filter 514 generates at least one separate dynamic conversation model 518a, 518b, . . . 518n (generically 518) for each corresponding conversation record. In some embodiments, a single ML module 516, i.e. with one natural language modeling algorithm, can be used to create separate dynamic conversation models 518 corresponding to each conversation record 502.

As illustrated in FIG. 6, most steps of method 600 closely match corresponding steps of method 400, save that conversational inclusion filter 614 generates conversation models 602 and updates message extraction parameters for each conversation, separately, when a new proposed message input is submitted (Step 606). Evaluation of threshold criteria at step 618, however, is expanded to address comparative relevance across multiple conversations, and consequently differs considerably from corresponding step 418 of method 400. More specifically, conversational inclusion filter 514 generates independent relevance scores for proposed message 512 using each dynamic conversational model 518 (Step 616), but evaluates these relevance scores for satisfaction of threshold criteria (Step 618) separately. The relevance score of proposed message 512 with respect to the conversation for which it was submitted can be evaluated substantially as described above with respect to FIG. 2 or 3. Low relevance according to this threshold evaluation triggers generation of a user prompt requesting confirmation of the potentially irrelevant message (Step 620) as discussed above. Additionally, conversational inclusion filter 514 compares the relevance score generated with respect to the originating conversation against relevance scores generated with respect to all alternative conversations. If relevance scores with respect to any alternative conversations exceed the relevance score of proposed message 512 with respect to its originating conversation, conversational inclusion filter 514 can propose that proposed message 512 has been misdirected, i.e. submitted in the wrong conversation thread. In some embodiments, the relevance scores of proposed message 512 with respect to each alternative conversation constitute additional threshold criteria for the relevance score of proposed message 612 with respect to its originating conversation, such that all satisfaction criteria are deemed satisfied only when the relevance score of proposed message 512 with respect its originating conversations exceeds all relevance scores with respect to alternative conversations. In other embodiments, the presence of an alternative conversation for which proposed message 512 has a higher relevance score triggers a stricter threshold of evaluation of proposed message 512 with respect to its originating conversation, but does not necessarily flag proposed message 512 as likely misdirected. According to this approach, a proposed message that is sufficiently relevant to its originating conversation thread will not be presumed to be misdirected simply because it would also match another conversation thread more closely.

If proposed message 512 appears to be irrelevant to its originating conversation thread or misdirected from another conversation thread, conversation inclusion filter 514 generates a user prompt requiring a decision from local user 504, much as described previously. (Step 620). If proposed message 512 merely appears irrelevant to its originating conversation thread, this prompt queries whether the potentially irrelevant message is approved (i.e. in its originating conversation thread) or disapproved, as described above with respect to FIGS. 2 and 3. If proposed message 512 is flagged as likely misdirected, however, the user prompt can in some examples provide additional options to local user 504 allowing proposed message 512 to be redirected to, e.g., any other conversation for which its relevance score is higher, or alternatively to the single conversation with the highest corresponding relevance score. If local user 504 altogether disapproves the message, it is discarded or retained as described with respect to FIGS. 2-4. Otherwise, proposed message 512 is transmitted as approved message 522. If local user 504 agrees in response to the user prompt (step 620) that the message has been misdirected and approves or selects an alternative conversation thread, then approved message 522 is submitted to that alternative conversation thread rather than the originating conversation.

The systems and methods described herein leverage machine learning to produce conversation models dynamically with each new message submitted by a user for transmission into a conversation thread. By evaluating new messages using these dynamic conversation models, these systems and methods reduce the likelihood that messages will be misdirected.

### Discussion of Detailed Embodiments

The following are non-exclusive descriptions of possible embodiments of the present invention.

A method of evaluating a proposed message for inclusion or exclusion in a first conversation, the method comprising: generating a first conversation record comprising a first plurality of messages transmitted within a first conversation; extracting a relevant subset of the first plurality of messages based on message extraction parameters; evaluating a thread length of the relevant subset of the first plurality of messages; generating a first conversation model from the relevant subset of the first plurality of messages in response to the evaluation indicating a sufficient thread length; scoring relevance of the proposed message according to the first conversation model; comparing the scored relevance against threshold criteria; and processing the proposed message based on the comparison of the scored relevance against threshold criteria, the processing of the proposed message comprising: submitting the proposed message to the first conversation in the event that the comparison of the scored relevance against the threshold criteria indicates sufficient correlation between the conversation and the proposed message; and otherwise generating a user prompt querying whether the proposed message should be submitted to the first conversation.

The method of the preceding paragraph can optionally include, additionally and/or alternatively, any one or more of the following features, configurations and/or additional components:

A further embodiment of the foregoing method, wherein the first conversation model is generated from the relevant subset of the first plurality of messages through operation of a machine learning (ML) module implementing a natural language modeling algorithm.

A further embodiment of the foregoing method, further comprising extracting semantically relevant text from the relevant subset of the first plurality of messages, wherein the conversational model is generated based on the semantically relevant text rather than the entirety of the relevant subset of the first plurality of messages.

A further embodiment of the foregoing method, wherein extracting semantically relevant text from the relevant subset of the first plurality of messages comprises: tokenizing words from among the relevant subset first plurality of messages; and stemming at least a subset of the tokenized words.

A further embodiment of the foregoing method, wherein extracting semantically relevant text from the relevant subset of the recorded messages comprises removing stop words and phrases from among the relevant subset of the first plurality of messages.

A further embodiment of the foregoing method, wherein evaluating the relevant subset of the first plurality of messages comprises identifying a count of the relevant subset of the first plurality of messages remaining after removing the stop words and phrases, and wherein evaluation indicates a sufficient thread length in the event that the count exceeds a threshold minimum count.

A further embodiment of the foregoing method, wherein evaluating the thread length comprises identifying a weighted count length of the first plurality of messages remaining after removing the stop words and phrases, wherein the weighted count assigns weights to the each of the relevant subset of the first plurality of messages based on at least one of age and length of each of the relevant subset of the first plurality of messages.

A further embodiment of the foregoing method, wherein: the first conversation record further comprising timestamps associated with each of the first plurality of messages; and extracting the relevant subset of the first plurality of messages comprises excluding messages from the relevant subset of the first plurality of messages based on age relative to the proposed message, as evaluated using the timestamps associated with each of the first plurality of messages.

A further embodiment of the foregoing method, wherein the first conversation record reflects the first conversation, the method further comprising: generating a second conversation record comprising a second plurality of messages transmitted within a second conversation; extracting a relevant subset of the second plurality of messages based the message extraction parameters; generating a second conversation model from the relevant subset of the second plurality of messages; scoring relevance of the proposed message according to the second conversation model; and comparing the scored relevance of the proposed message according to the first conversation model to the scored relevance of the proposed message according to the second conversation model.

A further embodiment of the foregoing method, wherein the threshold criteria include the scored relevance of the proposed message according to the second conversation model.

A further embodiment of the foregoing method, further comprising transmitting the proposed message as an approved message only in the event that either: the user responds to the query by approving the message; or the comparison of the scored relevance against the threshold criteria indicates sufficient correlation between the conversation and the proposed message.

A further embodiment of the foregoing method, wherein the user prompt generated based on the comparison of the scored relevance against threshold criteria also queries whether the proposed message should be redirected to the second conversation.

A further embodiment of the foregoing method, wherein the message extraction parameters are at least in part derived from at least a subset of the first conversation record.

A conversational input evaluation system comprising: a first conversation record archiving a first conversation comprising a first plurality of past messages; a local user input module accessible to a local user, the local user input configured to submit a proposed message from the local user for inclusion in the conversation; and a conversational inclusion filter configured to receive and evaluate the proposed messages. The conversational inclusion filter comprises: a first dynamic conversation model operable on the proposed message to generate a first relevance score denoting relevance of the proposed message to the first conversation; and a machine learning (ML) module configured to generate the first dynamic conversation model based on a current state of the first conversation record, wherein the conversational inclusion filter is configured to transmit a query to the local user in the event that the first relevance score fails to satisfy threshold criteria for relevance to the first conversation, and to permit the proposed message to be transmitted in the first conversation only in the event that either: the first relevance score generated for the proposed message indicates that the proposed message satisfies threshold criteria for relevance to the first conversation, or the local user confirms transmission of the proposed message in response to the query, via the local user input.

The conversational input evaluation system of the preceding paragraph can optionally include, additionally and/or alternatively, any one or more of the following features, configurations and/or additional components:

A further embodiment of the foregoing conversational input evaluation system, wherein the first conversation record is updated with each new message within the first conversation, and the ML module is configured to generate a new version of the first dynamic conversation model whenever the local user input module submits a new proposed message.

A further embodiment of the foregoing conversational input evaluation system, wherein the first conversation record further comprises a timestamp associated with each of the first plurality of past messages.

A further embodiment of the foregoing conversational input evaluation system, wherein the ML module is configured to generate the first dynamic conversation model from semantically relevant text derived from a relevant subset of the first conversation record extracted from the first conversation record based on message extraction parameters, the message extraction parameters comprising aging of the first plurality of past messages as assessed from the timestamps associated with each of the first plurality of past messages.

A further embodiment of the foregoing conversational input evaluation system, wherein the conversational inclusion filter is configured to derive the semantically relevant text from the relevant subset of the conversation record by: tokenizing words from among the relevant subset of the conversation record; stemming at least a subset of the tokenized words; and excluding semantically uninformative portions of the stemmed, tokenized words.

A further embodiment of the foregoing conversational input evaluation system, further comprising a second conversation record archiving a second conversation comprising a first plurality of past messages, wherein: the conversational inclusion filter further comprises a second dynamic conversation model operable on the proposed message to generate a second relevance score denoting relevance of the proposed message to the second conversation; the ML module is additionally configured to generate the second dynamic conversation model based on a current state of the second conversation record; and the threshold criteria include the second relevance score.

A further embodiment of the foregoing conversational input evaluation system, wherein the conversational inclusion filter permits the proposed message to be transmitted in second conversation only in the event that: the first and second relevance scores indicate that the proposed message is a closer match in relevance to the second conversation than to the first conversation; and the local user confirms redirection of the proposed message to the second conversation in response to the query, via the local user input.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of evaluating a proposed message for inclusion or exclusion in a first conversation, the method comprising:
generating a first conversation record comprising a first plurality of messages transmitted within a first conversation;
extracting a relevant subset of the first plurality of messages based on message extraction parameters;
evaluating a thread length of the relevant subset of the first plurality of messages;
generating a first conversation model from the relevant subset of the first plurality of messages in response to the evaluation indicating a sufficient thread length;
scoring relevance of the proposed message according to the first conversation model;
comparing the scored relevance against threshold criteria; and
processing the proposed message based on the comparison of the scored relevance against threshold criteria, the processing of the proposed message comprising:
submitting the proposed message to the first conversation in the event that the comparison of the scored relevance against the threshold criteria indicates sufficient correlation between the conversation and the proposed message; and otherwise
generating a user prompt querying whether the proposed message should be submitted to the first conversation.

2. The method of claim 1, wherein the first conversation model is generated from the relevant subset of the first plurality of messages through operation of a machine learning (ML) module implementing a natural language modeling algorithm.

3. The method of claim 1, further comprising extracting semantically relevant text from the relevant subset of the first plurality of messages, wherein the conversational model is generated based on the semantically relevant text rather than the entirety of the relevant subset of the first plurality of messages.

4. The method of claim 3, wherein extracting semantically relevant text from the relevant subset of the first plurality of messages comprises:
tokenizing words from among the relevant subset first plurality of messages; and
stemming at least a subset of the tokenized words.

5. The method of claim 3, wherein extracting semantically relevant text from the relevant subset of the recorded messages comprises removing stop words and phrases from among the relevant subset of the first plurality of messages.

6. The method of claim 5, wherein evaluating the relevant subset of the first plurality of messages comprises identifying a count of the relevant subset of the first plurality of messages remaining after removing the stop words and phrases, and wherein evaluation indicates a sufficient thread length in the event that the count exceeds a threshold minimum count.

7. The method of claim 5, wherein evaluating the thread length comprises identifying a weighted count length of the first plurality of messages remaining after removing the stop words and phrases, wherein the weighted count assigns weights to the each of the relevant subset of the first plurality of messages based on at least one of age and length of each of the relevant subset of the first plurality of messages.

8. The method of claim 1, wherein:
the first conversation record further comprising timestamps associated with each of the first plurality of messages; and
extracting the relevant subset of the first plurality of messages comprises excluding messages from the relevant subset of the first plurality of messages based on age relative to the proposed message, as evaluated using the timestamps associated with each of the first plurality of messages.

9. The method of claim 1, wherein the first conversation record reflects the first conversation, the method further comprising:
generating a second conversation record comprising a second plurality of messages transmitted within a second conversation;
extracting a relevant subset of the second plurality of messages based the message extraction parameters;
generating a second conversation model from the relevant subset of the second plurality of messages;
scoring relevance of the proposed message according to the second conversation model; and
comparing the scored relevance of the proposed message according to the first conversation model to the scored relevance of the proposed message according to the second conversation model.

10. The method of claim 9, wherein the threshold criteria include the scored relevance of the proposed message according to the second conversation model.

11. The method of claim 10, wherein the user prompt generated based on the comparison of the scored relevance against threshold criteria also queries whether the proposed message should be redirected to the second conversation.

12. The method of claim 1, further comprising transmitting the proposed message as an approved message only in the event that either:
the user responds to the query by approving the message; or
the comparison of the scored relevance against the threshold criteria indicates sufficient correlation between the conversation and the proposed message.

13. The method of claim 1, wherein the message extraction parameters are at least in part derived from at least a subset of the first conversation record.

14. A conversational input evaluation system comprising:
a first conversation record archiving a first conversation comprising a first plurality of past messages;
a local user input module accessible to a local user, the local user input configured to submit a proposed message from the local user for inclusion in the conversation; and
a conversational inclusion filter configured to receive and evaluate the proposed messages, the conversational inclusion filter comprising:
a first dynamic conversation model operable on the proposed message to generate a first relevance score denoting relevance of the proposed message to the first conversation; and
a machine learning (ML) module configured to generate the first dynamic conversation model based on a current state of the first conversation record,
wherein the conversational inclusion filter is configured to transmit a query to the local user in the event that the first relevance score fails to satisfy threshold criteria for relevance to the first conversation, and to permit the proposed message to be transmitted in the first conversation only in the event that either:
the first relevance score generated for the proposed message indicates that the proposed message satisfies threshold criteria for relevance to the first conversation, or
the local user confirms transmission of the proposed message in response to the query, via the local user input.

15. The conversational input evaluation system of claim 14, wherein the first conversation record is updated with each new message within the first conversation, and the ML module is configured to generate a new version of the first dynamic conversation model whenever the local user input module submits a new proposed message.

16. The conversational input evaluation system of claim 14, wherein the first conversation record further comprises a timestamp associated with each of the first plurality of past messages.

17. The conversational input evaluation system of claim 16, wherein the ML module is configured to generate the first dynamic conversation model from semantically relevant text derived from a relevant subset of the first conversation record extracted from the first conversation record based on message extraction parameters, the message extraction parameters comprising aging of the first plurality of past messages as assessed from the timestamps associated with each of the first plurality of past messages.

18. The conversational input evaluation system of claim 18, wherein the conversational inclusion filter is configured to derive the semantically relevant text from the relevant subset of the conversation record by:
tokenizing words from among the relevant subset of the conversation record;
stemming at least a subset of the tokenized words; and
excluding semantically uninformative portions of the stemmed, tokenized words.

19. The conversational inclusion filter of claim 14, further comprising a second conversation record archiving a second conversation comprising a first plurality of past messages, wherein:
the conversational inclusion filter further comprises a second dynamic conversation model operable on the proposed message to generate a second relevance score denoting relevance of the proposed message to the second conversation;
the ML module is additionally configured to generate the second dynamic conversation model based on a current state of the second conversation record; and
the threshold criteria include the second relevance score.

20. The conversational inclusion filter of claim 19, wherein the conversational inclusion filter permits the proposed message to be transmitted in second conversation only in the event that:
the first and second relevance scores indicate that the proposed message is a closer match in relevance to the second conversation than to the first conversation; and
the local user confirms redirection of the proposed message to the second conversation in response to the query, via the local user input.
